(19) United States
(12) Patent Application Publication
(10) Pub. No.: US 2024/0017164 A1
(43) Pub. Date: Jan. 18, 2024

(54) Method for Blood Tracking Game

(71) Applicant: Rich Gonzalez, Rocky Point, NC (US)

(72) Inventor: Rich Gonzalez, Rocky Point, NC (US)

(21) Appl. No.: 17/866,819

(22) Filed: Jul. 18, 2022

(51) Int. Cl. A63F 9/30; A63F 9/06

(52) U.S. Cl. CPC A63F 9/30; A63F 9/0641; A63F 2009/0658

(57) ABSTRACT

A method for tracking game includes identifying that a shot hit an animal; finding a blood trail from the animal; and marking the blood trail with an aqueous aerosol paint.

### BACKGROUND

The present disclosure relates to a method for tracking game.

Knowing how to blood trail and track an animal is essential. There is nothing worse than placing a shot, hitting the animal and not recovering the meat. If the animal dropped dead in its tracks, you can be thankful for the gift of its meat. If a hit was achieved but the animal ran off, this is when blood trailing and tracking comes into play. There's an incredible amount of information that needs to be gathered in the immediate moments following a shot.

### SUMMARY

A method for tracking game according to one disclosed non-limiting embodiment of the present disclosure includes identifying that a shot hit an animal; finding a blood trail from the animal; and marking the blood trail with an aqueous aerosol paint.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a method for blood tracking an animal according to one disclosed non-limiting embodiment.

### DETAILED DESCRIPTION

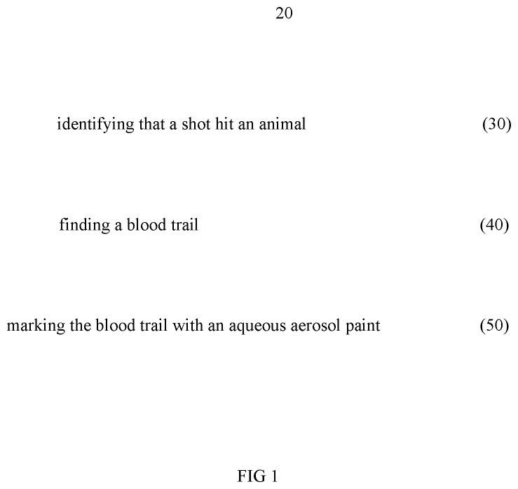

FIG. 1 schematically illustrates a method 20 for tracking game. The method generally includes identifying that a shot hit an animal (step 30). Take this time to analyze the details of the shot, the animal's position and the direction in which it ran.

Next, the hunter will find a blood trail from the animal (step 40). Depending on the time of day, environment, etc., only the first few drops of blood need be found. When tracking game, a hunter may wish to find the first evidence of a blood trail but then return later to the trail. For example, when hunting bear, if shot at night, the hunter may look for the initial evidence of the trail then wait till morning.

Next, the hunter will mark the blood trail with an aqueous aerosol paint (step 50). Paint compositions function by depositing a layer of pigment onto a substrate. The pigment is typically suspended or solubilized within a carrier fluid that volatilizes or dries after the paint composition is applied, leaving behind a hardened pigment film. A key performance characteristic of both organic solvent-based and water-based paints is to deposit a permanent film for surface protection. By contrast, a key performance characteristic of aqueous aerosol paints is to deposit a temporary film. A dot or small line parallel to the drops may be sprayed at one or more locations. The aqueous aerosol paint as described herein, may be an inverted spray can spray that has luminescent and/or reflective properties.

Alternatively, or in addition, the spray can be used for other outdoor activities such as hunting, hiking, camping, fishing, etc. It can make a trail day or night as a flashlight can be used for the reflective qualities.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

1. A method for blood tracking game, comprising:
determining that an animal received a ballistic wound;
identifying a blood trail of the animal by
determining an initial position of the blood trail;
determining a direction of the blood trail relative to the initial position; and
applying an aqueous aerosol paint proximate to the blood trail, the aqueous aerosol paint comprising a luminescent and/or reflective material.

2. The method as recited in claim 1, wherein
applying the aqueous aerosol paint comprises:
applying a line, using the aqueous aerosol paint, proximate to the blood trail that reflects a direction of the blood trail.

3. The method as recited in claim 1, further comprising:
illuminating the aqueous aerosol paint with a light source.
